(19) United States
(12) Patent Application Publication
(10) Pub. No.: US 2024/0368439 A1
(43) Pub. Date: Nov. 7, 2024

(54) ADHESIVE COMPOSITION AND USE THEREOF FOR PROVIDING A SELF-HEALING ADHERED ROOFING SYSTEMS

(71) Applicant: SIKA TECHNOLOGY AG, Baar (CH)

(72) Inventors: Carl WILFRIED, Wädenswil (CH); Josef VON ROTZ, Kerns (CH); Markus HAUFE, Zürich (CH)

(73) Assignee: SIKA TECHNOLOGY AG, Baar (CH)

(21) Appl. No.: 18/776,472

(22) Filed: Jul. 18, 2024

Related U.S. Application Data
(62) Division of application No. 16/644,889, filed on Mar. 5, 2020.

(30) Foreign Application Priority Data
Sep. 5, 2017 (EP) 17189495.9

(51) Int. Cl. C09J 111/00; C09J 7/35; C09J 7/38; C09J 11/04; C09J 11/08; C09J 107/00; C09J 115/02; C09J 123/22; C09J 201/00; E04D 1/34

(52) U.S. Cl. CPC C09J 111/00; C09J 11/04; C09J 11/08; C09J 107/00; C09J 115/02; C09J 123/22; C09J 201/00; E04D 1/34; C09J 7/35; C09J 7/38; C09J 2407/00; C09J 2411/00; C09J 2421/00; C09J 2423/00; C09J 2475/00; E04D 2001/3435; Y10T 428/2857; Y10T 428/2883

(57) ABSTRACT

An adhesive composition and use thereof for providing self-healing adhered roofing systems. The adhesive composition includes at least one rubber component, at least one organic solvent, and 12.5-40 wt.-% of at least one powdered superabsorber polymer, based on the total weight of the adhesive composition. Further, a self-healing membrane composite, to a method for forming a self-healing adhered roofing system, to a self-healing adhered roofing system and to use of at least one powdered superabsorber polymer in an adhesive for providing a self-healing adhered roofing system.

### CROSS-REFERENCE TO RELATED APPLICATIONS

This is a Divisional of application Ser. No. 16/644,889, filed Mar. 5, 2020, which in turn is a national phase of PCT/EP2018/073716, filed Sep. 4, 2018, which claims the benefit of EP 17189495.9, filed Sep. 5, 2017. The disclosure of the prior applications is hereby incorporated by reference herein in its entirety.

### TECHNICAL FIELD

The invention relates to the field of adhesive compositions and use thereof for providing self-healing adhered waterproofing and roofing systems.

### BACKGROUND OF THE INVENTION

In the field of construction, polymeric sheets, which are often referred to as membranes or panels, are used to cover underground and above ground constructions, such as basements, tunnels, and flat and low-sloped roofs. The flat roof structures can be provided both as single-ply systems composed of one single roofing membrane adhered to the roof substrate or as multi-ply systems based on the use of roofing membranes composed of multiple layers of different materials. Both types of structures have their own advantages and disadvantages. Generally the single-ply structures have the advantage of lower production costs compared to multi-ply systems but they are also less resistant to mechanical damages caused by punctures of sharp objects.

Commonly used materials for single-ply roofing membranes include thermoplastics such as plasticized polyvinylchloride (PVC-p), thermoplastic olefins (TPE-O, TPO), and elastomers such as ethylene-propylene diene monomer (EPDM). Such membranes are typically delivered to a construction site in rolls, transferred to the place of installation, unrolled, and adhered to the roof substrate by using mechanical and/or adhesive means. The roof substrate on which the membrane is adhered may be comprised of variety of materials depending on the installation site. The roof substrate may be, for example, a concrete, metal, or wood deck, or it may include an insulation board or recover board and/or an existing membrane.

The roofing membranes must be secured to the roof substrate to provide sufficient mechanical strength to resist the shearing forces applied on it, for example due to high wind loads. The membrane can be mechanically fastened to the roof substrate using screws and/or barbed plates. Mechanical fastening enables high strength bonding but it provides direct attachment to the roof substrate only at locations where a mechanical fastener affixes the membrane to the surface, which makes mechanically attached membranes susceptible to flutter. Membranes can also be secured to the roof substrate by adhesive attachment, which allows the formation of a fully adhered roofing system. In this case the majority, if not all, of the membrane is secured to the roof substrate by using adhesive bonding.

Fully adhered roofing systems can be prepared by using a number of techniques. The roofing membrane may be adhered to the roofing substrate by a method of contact bonding. In this case both the membrane and the surface of the roof substrate are first coated with a solvent or water based contact adhesive after which the membrane is contacted with the surface of the substrate. The volatile components of the contact adhesive are “flashed off” to provide partially dried adhesive films prior to contacting the membrane with the substrate. A fully adhered roofing system can also be prepared by using membrane composites having a pre-applied adhesive layer coated onto one of the major surfaces of the membrane. Typically the pre-applied adhesive layer is covered with a release liner to prevent premature unwanted adhesion and to protect the adhesive layer from moisture, fouling, and other environmental factors. At the time of use the release liner is removed and the membrane is secured to the substrate without using additional adhesives. Roofing membranes having a pre-applied adhesive layer covered by release liner are also known as “peel and stick membranes”.

In order to create a waterproofed roof constructions based on the use of multiple membranes having a width less than the waterproofed area, the edges of adjacent membranes must be overlapped to form sealable joints. These joints can be sealed by bonding the bottom surface an overlapping edge to the top surface of another overlapping edge or by using sealing tapes bonded to top surfaces of both overlapping edges. The technique for bonding the overlapping surfaces of the adjacent membranes depends on the materials of the membranes and also on the type of the roof substrate. In case of membranes composed of thermoplastic or non-crosslinked elastomeric materials, the overlapping portions of adjacent membranes can be bonded to each other by heat-welding. The adhesive bonding of the overlapping portions can be conducted using the same or different adhesive as that used for bonding the membranes to the roofing substrate.

Irrespective of the means used for securing the roofing membranes to the roof substrate, a modern single-ply flat roof structures have a general disadvantage of having low resistance to mechanical impacts caused by objects falling on the roof. Damaging of the membrane may occur, for example, during the construction or inspection phases or as a result of hailstone impacts. Such damages may also be generated by extensive traffic across the roof surface or by storing of heavy equipment on the roof, for example, during façade cleaning. Once the roofing membrane has been damaged, it cannot anymore perform its waterproofing function, which results in water ingress into the building with subsequent damage to the building structure and goods inside the building.

When the leakage in the membrane is discovered, the repair typically consists of patching the opening and thereby leaving the moisture trapped in the system. In a typical adhered roof system, the trapped moisture will degrade the adhesive bond and/or the cohesive strength of the top surface of the insulation or cover board below causing localized delamination of the assembly and making the roof susceptible to significant damage under wind load. Furthermore, small breaches in membranes are often difficult to localize and in many cases the leakage is discovered only after the water has already caused significant damage to the building structures. The concept of self-healing structures has been known for many years and it has been successfully used, for example, in sealing of tire punctures.

WO 2010/070466 A1 discloses a waterproof lamination roof underlay with nail-hole sealing property, which is based on the use of a copolymer sealing layer composed of ethylene methyl acrylate thermoplastic resin between the other layers of a multiple waterproof roof underlay structure. The technical solution presented in WO 2010/070466 A1 is based on creeping of highly viscous sealing layer. This process is very slow and it requires elevated temperature and a pressure gradient, both of which may not be available when a leak in a roofing membrane has to be blocked. The method is also limited to sealing of gaps between intruding foreign objects, such as nails, and the body of the membrane but it is not suitable for sealing a hole in the membrane. There thus remains a need for improved self-healing fully adhered roofing systems, which are able to maintain their watertightness even in case of mechanical damages caused by punctures of sharp objects.

### SUMMARY OF THE INVENTION

The object of the present invention is to provide an adhesive composition, which can be used for providing self-healing fully adhered roofing systems, which maintain their watertightnesss in case of mechanically damaged roofing membrane.

Another object of the present invention is to provide a method for forming self-healing adhered roofing systems.

The subject of the present invention is an adhesive composition as defined in claim 1.

It was surprisingly found out that an adhesive composition comprising a certain amount of powdered superabsorber polymers can be used for providing self-healing adhered roofing systems.

One of the advantages of the adhesive composition of the present invention is that it has sufficient water absorption capacity, which is responsible for the self-healing effect in adhered roofing systems but it also provides good adhesion on most of the materials used in typical roof substrates.

Another advantage of the adhesive composition of the present invention is that it can be used as a contact adhesive for bonding roofing membranes to substrates to form fully adhered roofing systems.

Other aspects of the present invention are presented in other independent claims. Preferred aspects of the invention are presented in the dependent claims.

### BRIEF DESCRIPTION OF THE DRAWINGS

FIG. 1 shows a cross-section of a self-healing fully adhered roofing system in case of damaged roofing membrane.

FIG. 2 shows a cross-section of a fully adhered roofing system without self-healing effect in case of damaged roofing membrane.

### DETAILED DESCRIPTION OF THE INVENTION

The subject of the present invention is an adhesive composition comprising:
a) At least one rubber component,
b) At least one organic solvent,
c) At least one powdered superabsorber polymer, wherein the at least one powdered superabsorber polymer comprises 12.5-40 wt.-% of the total weight of the adhesive composition.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “rubber” refers to any natural, synthetic, or modified high molecular weight polymer or combination of polymers, which is capable of recovering from large deformations, i.e. has elastic properties. The term “rubber” may be used interchangeably with the term “elastomer.” In particular, the term “rubber” refers to rubbers that are not chemically crosslinked. The term “chemically crosslinked” is understood to mean that the polymer chains forming the rubber are inter-connected by a plurality of covalent bonds, which are mechanically and thermally stable.

The term “organic solvent” refers to non-aqueous solvents and combinations of non-aqueous solvents, and, in particular, to solvents comprising organic compounds.

The term “superabsorber polymer” or “super absorbent polymer” refers to special class of polymers that can absorb and retain extremely large amounts of a liquid relative to their own mass. For example, such superabsorber polymers may be able to absorb up to 300 times its weight of water.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight may be determined by gel permeation chromatography.

The “amount or content of at least one component X” in a composition, for example “the amount of the at least one rubber component” refers to the sum of the individual amounts of all rubber components contained in the composition. For example, in case the composition comprises 20 wt.-% of at least one rubber component, the sum of the amounts of all rubber components contained in the composition equals 20 wt.-%.

The term “contact adhesive” refers to a type of adhesive used by contact bonding method. The term “bond adhesive” may be used interchangeable with the term “contact adhesive”.

The term “room temperature” designates a temperature of 23° C.

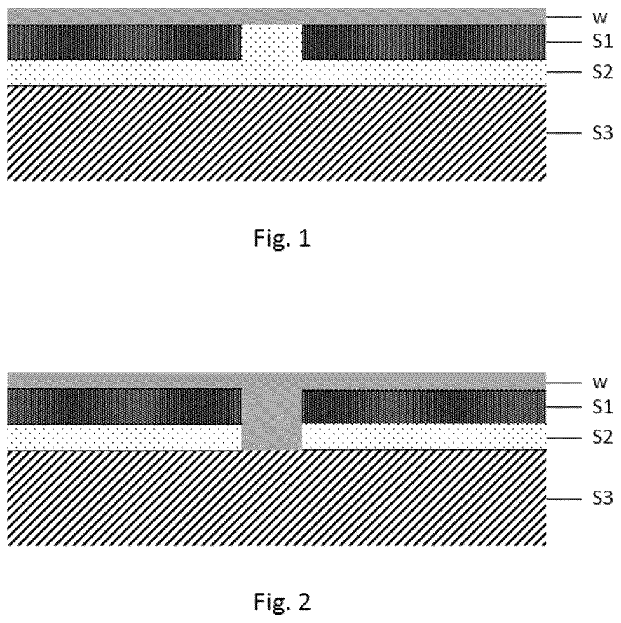

The self-healing effect obtained by the use of the adhesive composition of the present invention is based on swelling of adhesive layer by contact with water leaking through a damaged waterproofing layer. The swelling of the adhesive layer results from water being absorbed inside the superabsorber polymer particles contained in the adhesive composition and the extent of swelling is directly proportional to the amount of the powdered superabsorber polymer. In case of a self-healing adhered roofing system as presented in FIG. 1, the layer of adhesive composition (S2) between the roofing membrane (S1) and the roof substrate (S3) starts to swell after being contacted with water (w) leaking through a breach in the membrane. The swelling of the layer of adhesive composition (S2) results from water being absorbed inside the superabsorber particles contained in the adhesive composition. The amount of swelling has to be sufficient to enable the adhesive layer to fill the whole volume of the breach and to form a “sealing plug” against leaking water, as presented in FIG. 1. In case the water absorbing capacity of the adhesive composition is too low, no sealing plug is formed and water can continue to flow through the breach of the roofing membrane as presented in FIG. 2.

Therefore, the amount of the powdered superabsorber polymer in the adhesive composition has to be high enough to enable the formation of the “sealing plug” against water leaking though a damaged membrane in fully adhered roofing systems. It was, however, also found out that the amount of the powdered superabsorber polymer cannot be increased above a certain limit without having negative impact on the other application relevant properties of the adhesive composition, in particular, adhesive bond strength. In case the amount of the powdered superabsorber in the adhesive composition was below 10 wt.-%, only a partial self-healing effect was observed, i.e. the water penetration through hole in a membrane was reduced but not fully eliminated. It was also found out that increasing the amount of superabsorber in the adhesive composition over 40 wt.-% resulted in significant deterioration of the peel strengths obtained by use of the adhesive composition. Preferably, the adhesive composition comprises 15-40 wt.-%, more preferably 15-35 wt.-%, even more preferably 15-30 wt.-%, most preferably 15-25 wt.-%, based on the total weight of the adhesive composition, of at least one powdered superabsorber polymer. The amount of the at least one powdered superabsorber polymer in the adhesive composition refers in the present disclosure to the amount of dry superabsorber polymer, i.e. to the amount of the at least one powdered superabsorber without the amount of water, which may be contained, i.e. absorbed in the at least one powdered superabsorber polymer.

The type of the at least one superabsorber polymer used in the adhesive composition is not particularly restricted. Suitable powdered superabsorber polymers include known homo- and co-polymers of (meth)acrylic acid, (meth)acrylonitrile, (meth)acrylamide, vinyl acetate, vinyl pyrrolidone, maleic acid, maleic anhydride, itaconic acid, itaconic anhydride, vinyl sulfonic acid or hydroxyalkyl esters of such acids, wherein 0-95% by weight of the acid groups have been neutralized with alkali or ammonium groups and wherein these polymers/copolymers are crosslinked by means of polyfunctional compounds. Suitable superabsorber polymers are commercially available from BASF under the trade name of HySorb®, from Evonik under the trade name of FAVOR® and Creabloc®, and from Nippon Shokubai under the trade name of AQUALIC® CA.

The particle size of the at least one the powdered superabsorber polymer is not particularly restricted. The at least one powdered superabsorber polymer may have a median particle size d₅₀ of less than 500 μm, preferably less than 400 μm, more preferably less than 200 μm, even more preferably less than 150 μm, most preferably less than 100 μm. According to one or more embodiments, the at least one powdered superabsorber polymer has a median particle size d₅₀ in the range of 5-250 μm, preferably 15-150 μm, more preferably 20-125 μm, most preferably 25-100 μm. The term median particle size d₅₀ refers to a particle size below which 50% of all particles by volume are smaller than the d₅₀ value.

The term “particle size” refers in the present document to the area-equivalent spherical diameter of a particle. The particle size distribution can be determined by sieve analysis according to the method as described in ASTM C136/C136M-14 standard (“Standard Test Method for Sieve Analysis of Fine and Coarse Aggregates).

The amount of the at least one rubber component in the adhesive composition is not particularly restricted. Preferably, the adhesive composition comprises 5.0-60.0% by weight, more preferably 10.0-50.0% by weight, even more preferably 10.0-35.0% by weight, most preferably 10.0-30.0% by weight, based on the total weight of the adhesive composition, of the at least one rubber component.

According to one or more embodiments, the at least one rubber component is substantially completely dissolved in the at least one organic solvent. By the wording “substantially completely dissolved” is meant that at least 90 wt.-%, preferably at least 95 wt.-%, more preferably at least 97.5 wt.-%, even more preferably at least 99 wt.-%, most preferably at least 99.5 wt.-% of the at least one rubber component is dissolved in the at least one organic solvent. Such adhesive compositions are also known as solvent-based solution adhesives.

According to one or more embodiments, the adhesive composition comprises not more than 5.0 wt.-%, preferably not more than 4.5 wt.-%, even more preferably not more than 3.0 wt.-%, most preferably not more than 2.5 wt.-%, based on the total weight of the adhesive composition, of water. Preferably, substantially the entire amount, such as 97.5 wt.-%, preferably 99.9 wt.-% of the water contained in the adhesive composition is absorbed in the at least one powdered superabsorber polymer. Preparing adhesive compositions that are completely free of water may not be preferred since the at least one powdered superabsorber polymer typically has a moisture content in the range of 5-10 wt.-% when stored in normal atmospheric conditions (23° C., 50% relative humidity).

It may also be preferable that the adhesive composition is an anhydrous adhesive composition. The term “anhydrous adhesive composition” refers in the present disclosure to adhesive compositions having a water content of less than 1.0 wt.-%, preferably less than 0.5 wt.-%, excluding the amount of water that may be contained in the at least one powdered superabsorber polymer. Solvent based solution adhesives have been found be advantageous in the present invention since they provide sufficient peel strengths while being used for providing adhered roofing systems, in particular in single-ply adhered roofing systems, and since they can be easily mixed with powdered superabsorber polymers to enable sufficient water absorption capacity of the adhesive composition.

The amount and type of the at least one organic solvent contained in the adhesive composition is not particularly restricted. Typically, the amount and the type of the at least one organic solvent is selected based on the type and amount of the at least one rubber component contained in the adhesive composition. It may be preferable that the adhesive composition comprises 40-90 wt.-%, more preferably 45-85 wt.-%, even more preferably 50-85 wt.-%, in particular 50-80 wt.-%, most preferably 50-75 wt.-%, based on the total weight of the adhesive composition, of the at least one organic solvent.

Suitable organic solvents may have a boiling point that is not above 250° C., preferably not above 200° C., most preferably not above 150° C. The term ‘boiling point’ refers in the present document to the standard boiling point, i.e. the boiling point at a pressure of 1 bar. The standard boiling point of a composition can be determined, for example, with an ebulliometer.

Preferably, the at least one organic solvent has a Hildebrandt solubility parameter δ in the range of 5-40 MPa^{1/2}, more preferably 10-30 MPa^{1/2} and/or a relative evaporation rate determined according to DIN 53170 standard of not more than 40, more preferably not more than 30, even more preferably not more than 20.

The Hildebrandt solubility parameter δ can be calculated using the equation:

$$δ = \sqrt{\frac{Δ {H}_{v} - R T}{{V}_{m}}} ,$$

wherein ΔHᵥ is heat of vaporization,
R is gas constant,
T is temperature, and
Vₘ is molar volume.

The relative evaporation rate is the quotient of the evaporation time of the test liquid and that of diethyl ether as reference liquid at a temperature of 293±2 K and at a relative humidity of 65%±5%.

Organic solvents having the Hildebrandt solubility parameter δ^{1/2} within the above cited ranges have been found out to be preferable for use in the adhesive composition since the at least one rubber component has a high solubility in these types of organic solvents. On the other hand, organic solvents having a relative evaporation rate within the above cited ranges have been found out to be preferably for use in adhesive compositions, which are used in contact bonding applications.

Suitable organic solvents for the adhesive composition include oxygenated, aliphatic and aromatic hydrocarbon solvents and mixtures thereof. Suitable oxygenated hydrocarbon solvents include, for example, ethyl acetate, acetone, tetrahydrofuran, methyl ethyl ketone, methyl isobutyl ketone, methyl n-butyl ketone, and other ketone and ester based solvents. Suitable aliphatic and aromatic hydrocarbon solvents include, for example, pentane, cyclohexene, cyclohexane, n-hexane, n-heptane, and octane, benzene, naphthalene, toluene, and xylene. Preferably, the at least one organic solvent is selected from the group consisting of ethyl acetate, acetone, tetrahydrofuran, methyl ethyl ketone, methyl isobutyl ketone, methyl n-butyl ketone, toluene, xylene, pentane, cyclohexene, cyclohexane, n-hexane, n-heptane, and octane. According to one or more embodiments, the at least one organic solvent is selected from the group consisting of ethyl acetate, acetone, tetrahydrofuran, methyl ethyl ketone, methyl isobutyl ketone, and methyl n-butyl ketone. According to one or more further embodiments, the at least one organic solvent is selected from the group consisting of pentane, cyclohexene, cyclohexane, n-hexane, n-heptane, octane, benzene, naphthalene, toluene, and xylene. Mixtures of oxygenated hydrocarbon solvents and aliphatic and/or aromatic hydrocarbon solvents may also be used.

The type of the at least one rubber component is not particularly restricted. Any rubber component typically used in solvent-based solution adhesives can be used in the adhesive composition. It may, however, be preferable that the at least one rubber component is selected from the group consisting of chloroprene rubber, butyl rubber, halogenated butyl rubber, acryl nitrile rubber, natural rubber, polyisobutylene, and polyurethane rubber. According to one or more embodiments, the at least one rubber component is selected from the group consisting of chloroprene rubber, butyl rubber, halogenated butyl rubber, acryl nitrile rubber, and natural rubber.

According to one or more embodiments, the adhesive composition further comprises 0.1-20.0 wt.-%, preferably 0.5-15.0 wt.-%, more preferably 0.5-10.0 wt.-%, most preferably 1.0-5.0 wt.-%, based on the total weight of the adhesive composition, of particles of non-hydrated cement. The term “non-hydrated cement” refers to cement, which has not been mixed with water and reacted in a hydration reaction.

The cement contained in the adhesive composition can be any conventional cement, for example, one in accordance with the five main cement types according to DIN EN 197-1: namely, Portland cement (CEM I), Portland composite cements (CEM II), blast-furnace cement (CEM III), pozzolan cement (CEM IV) and composite cement (CEM V). These main cement types are subdivided, depending on the amount added, into an additional 27 cement types, which are known to the person skilled in the art and listed in DIN EN 197-1. Naturally, all other cements that are produced according to another standard are also suitable, for example, according to ASTM standard or Indian standard. To the extent that reference is made here to cement types according to DIN standard, this naturally also relates to the corresponding cement compositions which are produced according to another cement standard.

The particle size of the particles of non-hydrated cement is not particularly restricted. It may be preferable that the particles of non-hydrated cement have a median particle size d₅₀ of not more than 150 μm, such as not more than 100 μm, preferably not more than 75, most preferably not more than 50 μm. The median particle size d₅₀ of the non-hydrated cement particles may be, for example, in the range of 1-150 μm, preferably 2.5-100 μm, more preferably 5-75 μm, most preferably 7.5-50 μm.

According to one or more embodiments, the adhesive composition further comprises at least one hydrocarbon resin and/or at least one synthetic thermosetting resin, and/or at least one adhesion promoter. The at least one hydrocarbon resins is preferably selected from the group consisting of natural resins, chemically modified natural resins, and petroleum hydrocarbon resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “petroleum hydrocarbon resin” refers in the present document to synthetic hydrocarbon resins made by polymerizing mixtures of unsaturated monomers that are obtained from petroleum based feedstocks, such as from by-products of cracking of natural gas liquids, gas oil, or petroleum naphthas. These include also pure monomer aromatic resins, which are made by polymerizing aromatic monomer feedstocks that have been purified to eliminate color causing contaminants and to precisely control the composition of the product. Petroleum hydrocarbon resins typically have a relatively low average molecular weight, such in the range of 250-5,000 g/mol, and a glass transition temperature of above 0° C., preferably equal to or higher than 15° C., more preferably equal to or higher than 30° C.

Suitable hydrocarbon petroleum resins include C5 aliphatic petroleum hydrocarbon resins, mixed C5/C9 aliphatic/aromatic petroleum hydrocarbon resins, aromatic modified C5 aliphatic petroleum hydrocarbon resins, cycloaliphatic petroleum hydrocarbon resins, mixed C5 aliphatic/cycloaliphatic petroleum hydrocarbon resins, mixed C9 aromatic/cycloaliphatic petroleum hydrocarbon resins, mixed C5 aliphatic/cycloaliphatic/C9 aromatic petroleum hydrocarbon resins, aromatic modified cycloaliphatic petroleum hydrocarbon resins, C9 aromatic petroleum hydrocarbon resins, as well hydrogenated versions of the aforementioned resins. The notations “C5” and “C9” indicate that the monomers from which the resins are made are predominantly hydrocarbons having 4-6 and 8-10 carbon atoms, respectively. The term “hydrogenated” includes fully, substantially as well as at least partially hydrogenated resins. Partially hydrogenated resins may have a hydrogenation level, for example, of 50%, 70%, or 90%.

Suitable synthetic thermosetting resins to be used in the adhesive composition include those materials obtained by the condensation of phenol or substituted phenol with an aldehyde. These materials may also be referred to as phenolic resins or phenol formaldehyde resins.

The adhesive composition may further comprise one or more additives selected from reinforcing and non-reinforcing fillers, UV absorbers, UV stabilizers, heat stabilizers, antioxidants, flame retardants, optical brighteners, pigments, dyes, and biocides. Suitable fillers that can be used include inorganic fillers such as calcium carbonate, clays, silica, talc, titanium dioxide, magnesium oxide, zinc oxide, carbon black, and mixtures thereof. The additives, if used at all, preferably comprise not more than 20 wt.-%, more preferably not more than 15 wt.-%, most preferably not more than 10 wt.-%, of the total weight of the adhesive composition.

The preferences given above for the at least one powdered superabsorber polymer apply equally to all aspects of the present invention unless otherwise stated.

Another subject of the present invention is a self-healing membrane composite comprising:
a) A waterproofing membrane having first and second major surfaces and
b) A layer of anhydrous adhesive composition coated on and covering at least portion the second major surface of the waterproofing membrane,
   wherein the anhydrous adhesive composition comprises at least 35 wt.-%, preferably at least 40 wt.-%, more preferably at least 45 wt.-%, of at least one powdered superabsorber polymer, said proportions being based the total weight of the adhesive composition excluding the weight of organic solvent(s) that may be present.

The amount of the at least one powdered superabsorber polymer in the anhydrous adhesive composition refers in the present disclosure to the amount of dry superabsorber polymer, i.e. to the amount of the at least one powdered superabsorber without the amount of water, which may be contained, i.e. absorbed in the at least one powdered superabsorber polymer.

The term “anhydrous adhesive composition” refers in the present documents to adhesive compositions having a water content of less than 1.0 wt.-%, preferably less than 0.5 wt.-%, excluding the amount of water that may be contained in the at least one powdered superabsorber polymer.

The particles of the at least one superabsorber polymer are preferably distributed throughout the entire volume of the layer of anhydrous adhesive composition. The term “distributed throughout” is understood to mean that essentially all portions of the layer of adhesive composition contain superabsorber particles but it does not necessarily imply that the distribution of the superabsorber particles is completely uniform in the layer, i.e. the layer of anhydrous adhesive composition may contain regions, which have a slightly higher concentration of superabsorber particles than other regions.

According to one or more embodiments, the anhydrous adhesive composition further comprises at least one rubber component. The at least one rubber component is preferably selected from the group consisting of chloroprene rubber, butyl rubber, halogenated butyl rubber, acryl nitrile rubber, natural rubber, polyisobutylene, and polyurethane rubber.

Preferably, the at least one rubber component is present in the anhydrous adhesive composition in an amount of 25-80 wt.-%, more preferably 25-70 wt.-%, even more preferably 30-60 wt.-%, most preferably 30-55 wt.-%, said proportions being based the total weight of the anhydrous adhesive composition excluding the weight of organic solvent(s) that may be present.

Preferably, the self-healing membrane composite has a peel strength from a metal surface determined according to EN DIN 1372 standard of at least 10 N/50 mm, more preferably at least 15 N/50 mm, even more preferably at least 25 N/50 mm, most preferably at least 35 N/50 mm.

The waterproofing membrane is a sheet-like element having first and second major surfaces, i.e. top and bottom surfaces, defined by peripheral edges. The term “sheet-like element” refers in the present document to elements having a length and width at least 25 times, preferably at least 50 times, more preferably at least 150 times greater than the thickness of the element. The layer of anhydrous adhesive composition is coated on the second major surface of the waterproofing membrane, i.e. the layer of anhydrous adhesive composition is directly connected to the second major surface of the waterproofing membrane. The expression “directly connected” is understood to mean in the context of the present document that no further layer or substance is present between the second major surface of the waterproofing membrane and the layer of anhydrous adhesive composition.

The layer of anhydrous adhesive composition may be coated on portion of the second major surface of the waterproofing membrane or substantially on the entire area of the second major surface of the waterproofing membrane. It may preferable that at least 50%, more preferably at least 70%, most preferably at least 90%, of the area of the second major surface of the waterproofing membrane is covered by the layer of adhesive anhydrous adhesive composition. In case the anhydrous adhesive composition is used for bonding the overlapping portions of adjacent membrane composites, the layer of anhydrous adhesive composition is preferably coated on substantially the entire area of the second major surface of the waterproofing membrane. The term “substantially entire area” refers here to at least 95% of the area, preferably at least 97.5% of the area.

Preferably, the waterproofing membrane comprises a waterproofing layer having first and second major surfaces defining a thickness there between. The waterproofing membrane may be a single-ply waterproofing membrane comprising one single waterproofing layer or a multi-ply waterproofing membrane comprising of two or more waterproofing layers having same or different compositions. Both single-ply and multi-ply waterproofing membranes may comprise, in addition to the waterproofing layer(s), one or more reinforcement layers to improve the dimensional stability and strength of the waterproofing membrane. It may, however, be also possible or even preferred that the waterproofing membrane does not contain any reinforcing layers. The reinforcement layers, if used, are preferably fully embedded into the waterproofing layer(s). By the expression “fully embedded” is meant that the reinforcing layer is fully covered by the matrix of the waterproofing layer. In case of a multi-ply waterproofing membrane, the term “first and second major surfaces of the waterproofing membrane” refer to the first and second primary exterior surfaces of the multi-ply membrane. Such single-ply and multi-ply waterproofing membranes are known to a person skilled in the art and they may be produced by any conventional means, such as by way of extrusion or co-extrusion through a conventional extrusion die, calendaring or by spread coating.

According to one or more embodiments, the waterproofing membrane is a single-ply waterproofing membrane comprising one single waterproofing layer, preferably composed of a polymeric material. In these embodiments, the second major surface of the waterproofing layer constitutes the second major surface of the waterproofing membrane. It is possible that the single-ply waterproofing membrane comprises, in addition to the waterproofing layer, a reinforcement layer, such as a layer of fiber material, a mesh, or a scrim, for example, a polyester scrim, which is fully embedded into the waterproofing layer.

The term “fiber material” refers in the present document to materials composed of fibers. The fibers can comprise or consist of organic or synthetic material. These include in particular cellulose fibers, cotton fibers, protein fibers, synthetic organic fibers, and synthetic inorganic fibers. Suitable synthetic fibers include fibers made of polyester, a homopolymer or copolymer of ethylene and/or propylene, viscose, nylon, and glass. The fibers can be short fibers or long fibers, spun, woven or unwoven fibers or filaments. The fibers can moreover be aligned or drawn fibers.

Moreover, it may be advantageous to use different fibers, both in terms of geometry and composition, together.

According to one or more further embodiments, the waterproofing membrane is a multi-ply waterproofing membrane comprising top and bottom waterproofing layers, preferably composed of a polymeric material. In these embodiments, the second major surface of the bottom waterproofing layer constitutes the second major surface of the waterproofing membrane. The top and bottom waterproofing layers are preferably directly connected with each other over at least portion of their opposing major surfaces, i.e. at least portion of the second major surface of the top waterproofing layer is directly connected to the first major surface of the bottom waterproofing layer. The top waterproofing layer may be homogeneous or comprise a reinforcement layer, such as a layer of fiber material, a mesh, or a scrim, for example, a polyester scrim, which is fully embedded into the top waterproofing layer.

It can be advantageous that the waterproofing membrane further comprises a top-coating, which is applied on the first major surface of the waterproofing membrane facing away from the layer of anhydrous adhesive composition. The top-coating may comprise UV-absorbers and/or thermal stabilizers to protect the waterproofing membrane from damaging influence of sunlight. The top-coating may also comprise color pigments in order to provide the waterproofing membrane with a desired color.

The detailed composition of the waterproofing layer(s) is not particularly restricted. Any polymeric material providing sufficient watertightness can in principle be used. The waterproofing layer may comprise or be composed of at least one thermoplastic or at least one elastomeric polymer, preferably selected from the group consisting of polyvinylchloride (PVC), propylene diene rubber (EPR, EPDM), ethylene-vinyl acetate co-polymers (EVA), ethylene-acrylic ester copolymers, ethylene-α-olefin co-polymers, ethylene-propylene co-polymers, polypropylene (PP), polyethylene (PE), chlorosulfonated polyethylene (CSPE), or polyisobutylene (PIB), and mixtures thereof. According to one or more embodiments, the waterproofing layer comprises at least 50 wt.-%, preferably at least 60 wt.-%, more preferably at least 70 wt.-%, most preferably at least 85 wt.-%, based on the total weight of the waterproofing layer, of at least one thermoplastic or at least one elastomeric polymer selected from the group consisting of polyvinylchloride (PVC), propylene diene rubber (EPR, EPDM), ethylene-vinyl acetate co-polymers (EVA), ethylene-acrylic ester copolymers, ethylene-α-olefin co-polymers, ethylene-propylene co-polymers, polypropylene (PP), polyethylene (PE), chlorosulfonated polyethylene (CSPE), or polyisobutylene (PIB).

The waterproofing membrane may have a thickness, measured by using the method as defined in DIN EN 1849-2 standard, of 0.1-20.0 mm, preferably 0.5-10.0 mm, more preferably 0.5-5.0 mm, most preferably 0.5-2.5 mm.

It may be preferable that the particles of the at least one super absorber polymer constitute not more than 15 wt.-%, preferably not more than 10 wt.-%, most preferably not more than 5 wt.-%, of the sum of weights of the waterproofing membrane and the layer of anhydrous adhesive composition.

The thickness of the layer of anhydrous adhesive composition depends on the type of adhesive composition and on the application related requirements, such as required adhesive bond strength between the waterproofing membrane and the substrate on which the membrane is bonded using the layer of anhydrous adhesive composition. It may be preferable that the layer of anhydrous adhesive composition has a coating weight in the range of 100-1500 g/m², more preferably 150-1250 g/m², most preferably 250-1000 g/m².

The anhydrous adhesive composition is preferably a structural adhesive, more preferably a structural adhesive selected from the group consisting of solvent-based adhesives, polymer dispersion adhesives, pressure sensitive adhesives (PSA), non-reactive hot-melt adhesives (HMA), reactive hot-melt adhesives (R-HMA), and one and multi-component, in particular two-component, chemically curing adhesives such as those based on epoxy and polyurethane chemistry.

According to one or more embodiments, the anhydrous adhesive composition is the adhesive composition of the present invention. In this embodiment, the layer of anhydrous adhesive composition has preferably a wet coating weight of 150-1500 g/m², more preferably 250-1250 g/m², most preferably 350-1000 g/m². The term “wet coating weight” refers in the present document to the coating weight of the adhesive composition present on surface of a waterproofing membrane in wet state, i.e. before the liquid components, in particular solvents, present in the adhesive composition have been evaporated. Membrane composites having a layer of adhesive composition of the present invention coated on the surface of the waterproofing membrane with a wet coating weight in the above cited ranges have been found to provide sufficient adhesive bond strengths required in providing fully adhered roofing systems.

Another subject of the present invention is a method for forming a self-healing adhered roofing system, the method comprising steps of:
i) Applying an adhesive composition of the present invention to at least portion of a surface of a substrate to form a first continuous wet film of adhesive,
ii) Applying an adhesive composition of the present invention to at least portion of a second major surface of a roofing membrane to form a second continuous wet film of adhesive,
iii) Allowing the solvent contained in the wet adhesive films to at least partially evaporate to form first and second at least partially dried adhesive films suitable for contact bonding,
iv) Contacting the first at least partially dried adhesive film with the second at least partially dried adhesive film to form an adhesive bond between the roofing membrane and the substrate.

The adhesive composition may be applied on the surfaces of the substrate and roofing membrane by using any conventional means such as by using conventional rollers, power rollers, brushes, drop spreaders, squeegee, or by spraying. Preferably, the adhesive composition is applied the surface of the substrate and roofing membrane by using a roller, brush, squeegee, or by spraying.

The roofing membrane is a sheet-like element having first and second major surfaces, i.e. top and bottom surfaces, defined by peripheral edges. The adhesive composition may be applied to cover only a portion or substantially the entire area of the second major surface of the roofing membrane. It may be preferable that the adhesive composition is applied over at least 50%, more preferably at least 70%, most preferably at least 90%, of the area of the second major surface of the roofing membrane. In case the same adhesive composition is used for bonding the overlapping portions of adjacent roofing membranes, the adhesive composition is preferably applied over substantially the entire area of the second major surface of the roofing membrane.

According to one or more embodiments, the adhesive composition is applied on the second major surface of the roofing membrane with a wet coating weight of 150-1500 g/m², more preferably 250-1250 g/m², most preferably 350-1000 g/m². The term “wet coating weight” refers in the present document to the coating weight of the adhesive composition before the liquid components, in particular solvents, present in the adhesive composition have been evaporated. Wet coating weights of the adhesive composition in the above cited ranges have been found to provide sufficient adhesive bond strengths required in fully adhered roofing systems.

The structure of the roofing membrane is not particularly limited in the present invention but the membrane should fulfill the general requirements as defined in DIN 20000-201:2015-08 standard. Preferably, the roofing membrane comprises a waterproofing layer having first and second major surfaces defining a thickness there between. Both single-ply and multi-ply roofing membranes are suitable. Such single-ply and multi-ply roofing membranes are known to a person skilled in the art and they may be produced by any conventional means, such as by way of extrusion or co-extrusion through a conventional extrusion die, calendaring or by spread coating.

According to one or more embodiments, the roofing membrane is a single-ply roofing membrane comprising one single waterproofing layer, preferably composed of a polymeric material. In these embodiments, the second major surface of the waterproofing layer constitutes the second major surface of the roofing membrane. It is possible that the single-ply roofing membrane comprises, in addition to the waterproofing layer, at least one reinforcement layer, such as a layer of fiber material, a mesh, or a scrim, for example, a polyester scrim, which is fully embedded in the waterproofing layer. It is, however, also possible or even preferred that the singly-ply roofing membrane does not contain any reinforcing layers.

According to one or more further embodiments, the roofing membrane is a multi-ply roofing membrane comprising a top and a bottom waterproofing layer, preferably composed of a polymeric material. In these embodiments, the second major surface of the bottom waterproofing layer constitutes the second major surface of the roofing membrane. The top and bottom waterproofing layers are preferably directly connected with each other over at least portion of their opposing major surfaces, i.e. at least portion of the second major surface of the top waterproofing layer is directly connected to the first major surface of the bottom waterproofing layer. The top waterproofing layer may be homogeneous or comprise at least one reinforcement layer, such as a layer of fiber material, a mesh, or a scrim, for example, a polyester scrim, which is fully embedded into the top waterproofing layer. It is, however, also possible or even preferred that the multi-ply roofing membrane does not contain any reinforcing layers.

It can also be advantageous that the roofing membrane further comprises a top-coating, which is applied to the first major surface of the roofing membrane. The top-coating may comprise UV-absorbers and/or thermal stabilizers to protect the adhered roofing system from damaging influence of sunlight. The top-coating may also comprise color pigments in order to provide the roofing membrane with a desired color.

The detailed composition of the waterproofing layer(s) is not particularly restricted. Any polymeric material providing sufficient watertightness can in principle be used. The waterproofing layer may comprise or be composed of at least one thermoplastic or at least one elastomeric polymer, preferably selected from the group consisting of polyvinylchloride (PVC), propylene diene rubber (EPR, EPDM), ethylene-vinyl acetate co-polymers (EVA), ethylene-acrylic ester copolymers, ethylene-α-olefin co-polymers, ethylene-propylene co-polymers, polypropylene (PP), polyethylene (PE), chlorosulfonated polyethylene (CSPE), or polyisobutylene (PIB), and mixtures thereof. According to one or more embodiments, the waterproofing layer comprises at least 50 wt.-%, preferably at least 60 wt.-%, more preferably at least 70 wt.-%, most preferably at least 85 wt.-%, based on the total weight of the waterproofing layer, of at least one thermoplastic or at least one elastomeric polymer selected from the group consisting of polyvinylchloride (PVC), propylene diene rubber (EPR, EPDM), ethylene-vinyl acetate co-polymers (EVA), ethylene-acrylic ester copolymers, ethylene-α-olefin co-polymers, ethylene-propylene co-polymers, polypropylene (PP), polyethylene (PE), chlorosulfonated polyethylene (CSPE), or polyisobutylene (PIB).

The roofing membrane may have a thickness, measured by using the method as defined in DIN EN 1849-2 standard, of 0.1-20.0 mm, preferably 0.5-10.0 mm, more preferably 0.5-5.0 mm, most preferably 0.5-2.5 mm.

The roofing membrane is typically provided in a form of a prefabricated membrane, which is delivered to the construction site and unwound from rolls to provide sheets having a width of 1-5 m and length of several times the width. However, the membrane can also be used in the form of strips having a width of typically 1-20 cm, for example so as to seal joints between two adjacent roofing membranes. Moreover, the roofing membrane can also be provided in the form of planar bodies, which are used for repairing damaged locations in existing adhered roofing systems.

The substrate on which the roofing membrane is adhered is preferably selected from the group consisting of an insulation board, a cover board, and an existing roofing membrane.

The preferences given above for the roofing membrane apply equally to all aspects of the present invention unless otherwise stated.

Still another subject of the present invention is a self-healing adhered roofing system comprising:
a) A substrate,
b) A roofing membrane directly adhered over at least part of one of its major surfaces to a surface of the substrate with a layer of anhydrous adhesive composition,
   wherein the anhydrous adhesive composition comprises at least 35 wt.-%, preferably at least 40 wt.-%, more preferably at least 45 wt.-%, of at least one powdered superabsorber polymer, said proportions being based the total weight of the anhydrous adhesive composition excluding the weight of organic solvent(s) that may be present.

The amount of the at least one powdered superabsorber polymer in the anhydrous adhesive composition refers in the present disclosure to the amount of dry superabsorber polymer, i.e. to the amount of the at least one powdered superabsorber without the amount of water, which may be contained, i.e. absorbed in the at least one powdered superabsorber polymer.

The particles of the at least one superabsorber polymer are preferably distributed throughout the entire volume of the layer of anhydrous adhesive composition. The term “distributed throughout” is understood to mean that essentially all portions of the layer of adhesive composition contain superabsorber particles but it does not necessarily imply that the distribution of the superabsorber particles is completely uniform in the layer, i.e. the layer of anhydrous adhesive composition may contain regions, which have a slightly higher concentration of superabsorber particles than other regions.

According to one or more embodiments, the anhydrous adhesive composition further comprises at least on rubber component. The at least one rubber component is preferably selected from the group consisting of chloroprene rubber, butyl rubber, halogenated butyl rubber, acryl nitrile rubber, natural rubber, polyisobutylene, and polyurethane rubber.

Preferably, the at least one rubber component is present in the anhydrous adhesive composition in an amount of 25-80 wt.-%, more preferably 25-70 wt.-%, even more preferably 30-60 wt.-%, most preferably 30-55 wt.-%, said proportions being based the total weight of the anhydrous adhesive composition excluding the weight of organic solvent(s) that may be present.

The roofing membrane is directly adhered over a portion or over substantially the entire area of one of its major surfaces to the surface of the substrate. The expression “directly adhered” is understood to mean in the context of the present document that no further layer or substance is present between the major surface of the roofing membrane and the layer of anhydrous adhesive composition. It may be preferable that the roofing membrane is directly adhered to the surface of the substrate over at least 50%, more preferably at least 70%, most preferably at least 90%, of the area of one of the major surfaces of the roofing membrane. In case the anhydrous adhesive composition is used for bonding the overlapping portions of adjacent roofing membranes, the roofing membrane is preferably directly adhered to the surface of the substrate over substantially the entire area of one of the major surfaces of the roofing membrane.

The substrate of the self-healing adhered roofing system is preferably selected from the group consisting of an insulation board, a cover board, and an existing roofing membrane.

The thickness of the layer of anhydrous adhesive composition depends on the type of adhesive composition and on the application related requirements, such as required adhesive bond strength between the roofing membrane and the substrate on which the membrane is bonded using the layer of adhesive.

According to one or more embodiments, the thickness of the layer of anhydrous adhesive is 0.01-2.0 mm, preferably 0.025-1.5 mm, more preferably 0.05-1.0 mm, even more preferably 0.05-0.75 mm, most preferably 0.1-0.5 mm. The layer of anhydrous adhesive composition is preferably composed of the anhydrous adhesive composition in its cured state. The term “cured state” refers to a state of the adhesive composition after it has been physically and/or chemically cured. The type of curing mechanism depends on the embodiment of the anhydrous adhesive composition. For example in case the anhydrous adhesive composition is a of solvent-based solution adhesive, the cured state of the adhesive composition refers to the state of the adhesive composition after substantially complete evaporation of the organic solvent content(s).

It may be preferable that the particles of the at least one super absorber polymer constitute not more than 15 wt.-%, preferably not more than 10 wt.-%, most preferably not more than 5 wt.-%, of the sum of weights of the roofing membrane and the layer of anhydrous adhesive composition.

The anhydrous adhesive composition is preferably a structural adhesive, preferably selected from the group consisting of solvent-based adhesives, polymer dispersion adhesives, pressure sensitive adhesives (PSA), non-reactive hot-melt adhesives (HMA), reactive hot-melt adhesives (R-HMA), and one and multi-component chemically curing adhesives such as those based on epoxy and polyurethane chemistry.

Preferably, the layer of anhydrous adhesive composition has a water absorbing capacity in the range of 50-1000 g/m², in particular 100-1000 g/m², preferably 150-900 g/m². Even though the superabsorber polymers are generally able to absorb up to the 300 times of their weight of water in a state of free expansion, their water absorbing capacity is significantly reduced while being mixed with an anhydrous adhesive composition. For example in case of a solvent-based solution adhesive, the water absorbing capacity of the superabsorber polymer in the adhesive composition is limited to 20-40 times of the weight of the superabsorber polymer due to the restoring network forces of the dried rubber component.

According to one or more embodiments, the layer of anhydrous adhesive composition is composed of the adhesive composition of the present invention in its cured state. The cured state of the adhesive composition of the present invention refers to the state of the adhesive after substantially complete evaporation of the at least one organic solvent. The term “substantially complete evaporation” is understood to mean that at least 95 wt.-%, preferably at least 97.5 wt.-%, more preferably at least 99 wt.-% of the total weight of the organic solvents has been removed from the adhesive composition by evaporation.

Still another subject of the present invention is use of at least one powdered superabsorber polymer in an adhesive for providing a self-healing adhered roofing system, wherein the at least one powdered superabsorber polymer is present the adhesive in an amount of 12.5-40 wt.-%, preferably 15-40 wt.-%, more preferably 15-35 wt.-%, even more preferably 15-30 wt.-%, most preferably 15-25 wt.-%, based on the total weight of the adhesive, and wherein the self-healing adhered roofing system comprises a roof substrate and a roofing membrane having first and second major surfaces, wherein at least portion of the second major surface of the roofing membrane is adhesively adhered to a surface of the roof substrate using the adhesive.

Preferably, at least 50%, more preferably at least 75% of the second major surface of the roofing membrane is directly bonded to the surface of the roof substrate via an adhesive layer formed by using the adhesive. According to one or more embodiments, at least 85%, preferably at least 90% of the second major surface of the roofing membrane is directly bonded to the surface of the roof substrate via the adhesive layer.

The roof substrate is preferably selected from the group consisting of an insulation board, a cover board, and an existing roofing membrane.

According to one or more embodiments, the adhesive is the adhesive composition of the present invention.

### EXAMPLES

The followings compounds and products shown in Table 1 were used in the examples:

TABLE 1

| | | |
|---|---|---|
| Sarnacol 2170 | Contact adhesive with | Sika Corporation USA |
| | 20 wt.-% solids | |
| Creabloc SIS-TR | Superabsorber in | Evonik Industries |
| | particulate form | |
| Sarnafil G410-15 | PVC roofing membrane | Sika Corporation USA |

### Preparation of Test Specimens

The self-healing and adhesive bond strength of the inventive and comparative adhesive compositions were measured using composite test specimens comprised of a strip of Sarnafil G410-15 roofing membrane bonded on the top surface of a standard plywood substrate.

The exemplary adhesive compositions were produced by mixing Creabloc SIS-TR superabsorber particles with Sarnacol 2170 contact adhesive in amounts presented in Table 1 using a container with a suitable mixing apparatus.

For the production of test specimens, plywood substrates having dimensions of 5 cm×30 cm were first evenly covered with approximately ⅔ of an adhesive composition batch using a squeegee. The applied layer was dried for approximately 30 minutes until the surface of the adhesive was not anymore tacky. Then a strip of the Sarnafil roofing membrane having dimensions of 5 cm×30 cm was coated with the remaining ⅓ of the adhesive composition batch and the applied layer of adhesive was dried for approximately 3 minutes until the adhesive was slightly moist (“stringy” according to finger test). The two layers were then contacted after which the membrane strip and the plywood substrate were pressed together for a time of approximately 5 seconds using a weight of 1 kg. The thus obtained composite test specimens were stored for one week at normal room temperature and relative humidity (23° C., 50% RH) before determination of the self-healing and bond strength properties.

The adhesive compositions were applied on the surface of the ply wood substrates and roofing membrane strips such that the total wet coating weight of both adhesive layers before pressing the membrane strip together with the plywood substrate was approximately 750 g/m². After storing the test specimen for one week at room temperature the dry coating weight of the adhesive layer between the membrane strip and the plywood substrate was approximately 150 g/m².

### Self-Healing

The self-healing property of the adhesive compositions was determined by cutting a 10 mm×10 mm hole on the roofing membrane strip of each composite test specimen and setting the thus obtained sample under ponding water for a period of 1 hour. In case the adhesive composition swollen due to the water absorption was able to form “a sealing plug” filling the hole and thus to prevent water leaking through the hole, the adhesive composition was considered to have a full self-healing capacity as presented in FIG. 1. In case the swollen adhesive formed a “sealing plug” but it was not sufficient to fill the hole and to stop the water flow through the hole, the adhesive composition was considered to have a partial self-healing capacity. In case no sealing plug was formed, the adhesive composition was considered to have no self-healing capacity as presented in FIG. 2.

### Adhesive Bond Strength

The adhesive bond strength of the adhesive compositions was determined based on peel resistance measurements.

The average peel resistances upon peeling the roofing membrane strip from the surface of the plywood substrate were measured using a Zwick tensile testing apparatus equipped with a 90°-peeling device.

In the peel resistance measurement, the edges of the test specimen were first clamped with the grips of the material testing apparatus. Subsequently, the sample strip was peeled off from the surface of the ply wood substrate at a peeling angle of 90° and at a constant cross beam speed of 100 mm/min. The peeling of the sample strip was continued until a length of approximately 20 cm of the strip was peeled off from the surface of the substrate. The average peel resistance was calculated as average peel force per width of the strip [N/50 mm] during peeling over a length of approximately 12 cm thus excluding the first and last fifth of the total peeling length from the calculation.

The average peel resistance values presented in Table 1 have been calculated as an average of measured values obtained with two test specimen prepared using the same adhesive composition.

TABLE 2

| | Sarnacol | SAP | Self- | 90° C. peel strength |
|---|---|---|---|---|
| | 2170 [g] | [g] | healing | [N/50 mm] |
| Ref-1 | 100 | 0 | No | 60 |
| Ref-2 | 100 | 10 | Partial | 90 |
| Ex-1 | 100 | 20 | Yes | 130 |
| Ex-2 | 100 | 30 | Yes | 120 |
| Ex-3 | 100 | 40 | Yes | 120 |
| Ref-3 | 0 | 100 | Yes | 0 |

1. A method for forming a self-healing adhered roofing system, the method comprising:
applying an adhesive composition to: (i) at least a portion of a surface of a substrate to form a first continuous wet film of adhesive, and (ii) at least a portion of a second major surface of a roofing membrane to form a second continuous wet film of adhesive, the adhesive composition including:
a) at least one rubber component,
b) at least one organic solvent,
c) at least one powdered superabsorber polymer in an amount in a range of 12.5-40 wt.-% based on a total weight of the adhesive composition.
allowing the solvent contained in the wet adhesive films to at least partially evaporate to form first and second at least partially dried adhesive films suitable for contact bonding, and
contacting the first at least partially dried adhesive film with the second at least partially dried adhesive film to form an adhesive bond between the roofing membrane and the substrate.

2. The method according to claim 1, wherein the adhesive composition is applied over at least 50% of the second major surface of the roofing membrane.

3. The method according to claim 1, wherein the substrate is selected from the group consisting of an insulation board, a cover board, and an existing roofing membrane.

4. The method according to claim 1, wherein the at least one organic solvent is present in the adhesive composition in an amount in a range of 40 wt.-% to 90 wt.-%, based on the total weight of the adhesive composition.

5. The method according to claim 1, wherein the at least one organic solvent is present in the adhesive composition in an amount in a range of 50 wt.-% to 85 wt.-%, based on the total weight of the adhesive composition.

6. The method according to claim 1, wherein the at least one organic solvent is present in the adhesive composition in an amount in a range of 50 wt.-% to 75 wt.-%, based on the total weight of the adhesive composition.

7. The method according to claim 1, wherein the at least one powdered superabsorber polymer is present in the adhesive composition in an amount in a range of 15 wt.-% to 30 wt.-%.

8. The method according to claim 1, wherein the adhesive composition comprises no more than 5 wt.-% of water, based on the total weight of the adhesive composition.

9. The method according to claim 1, wherein the adhesive composition comprises no more than 2.5 wt.-% of water, based on the total weight of the adhesive composition.

10. A method for using at least one powdered superabsorber polymer in an adhesive to provide a self-healing adhered roofing system, the method comprising preparing the adhesive including the at least one powdered superabsorber polymer in an amount of 12.5-40 wt.-%, based on a total weight of the adhesive, wherein the self-healing adhered roofing system comprises a roof substrate and a roofing membrane having first and second major surfaces, wherein at least portion of the second major surface of the roofing membrane is adhesively adhered to a surface of the roof substrate by the adhesive.

11. The method according to claim 10, wherein at least 50% of the second major surface of the roofing membrane is directly bonded to the surface of the roof substrate via an adhesive layer formed by using the adhesive.

12. The method according to claim 10, wherein the adhesive includes an adhesive composition comprising:
a) at least one rubber component,
b) at least one organic solvent, and
c) the at least one powdered superabsorber polymer.

13. The method according to claim 12, wherein the at least one organic solvent is present in the adhesive composition in an amount in a range of 40 wt.-% to 90 wt.-%, based on the total weight of the adhesive composition.

14. The method according to claim 12, wherein the at least one organic solvent is present in the adhesive composition in an amount in a range of 50 wt.-% to 85 wt.-%, based on the total weight of the adhesive composition.

15. The method according to claim 12, wherein the at least one organic solvent is present in the adhesive composition in an amount in a range of 50 wt.-% to 75 wt.-%, based on the total weight of the adhesive composition.

16. The method according to claim 12, wherein the at least one powdered superabsorber polymer is present in the adhesive composition in an amount in a range of 15 wt.-% to 30 wt.-%.

17. The method according to claim 12, wherein the adhesive composition comprises no more than 5 wt.-% of water, based on the total weight of the adhesive composition.

18. The method according to claim 12, wherein the adhesive composition comprises no more than 2.5 wt.-% of water, based on the total weight of the adhesive composition.
